(19) United States
(12) Patent Application Publication
(10) Pub. No.: US 2002/0091907 A1
(43) Pub. Date: Jul. 11, 2002

(54) Method and apparatus for simplified research of multiple dynamic databases

(76) Inventors: Yannick Pouliot, San Mateo, CA (US); Kelly Felkins, Oakland, CA (US); James Bernstein, Brisbane, CA (US); Jeff Rule, San Francisco, CA (US); Edward Kiruluta, Oakland, CA (US); Chris Mader, El Sobrante, CA (US)

Correspondence Address: Charles E. Gotlieb, Innovation Partners, Suite 300, 540 University Avenue, Palo Alto, CA, 94301, US

(21) Appl. No.: 09/778,181

(22) Filed: Feb. 6, 2001

Related U.S. Application Data
(60) Provisional application No. 60/180,814, filed on Feb. 7, 2000.

(51) Int. Cl. G06F 7/00

(52) U.S. Cl. 712/1

(57) ABSTRACT

A method and apparatus assembles multiple databases from different remote sources, performs research using the database specified using an easy-to-use user web interface and indentifies whether results are relevant and notifies the user of relevant results. As the database change, the research may be automatically performed on the changed portion of the database, and relevant results identified. The user is then notified of relevant results as they are incorporated into the databases.

### BACKGROUND OF THE INVENTION

Research may be conducted using multiple databases. If each of the databases has its own user interface and formats results in a particular way, a researcher may need to learn how to operate and interpret results from each of the many databases available, a time consuming process. Nevertheless, the reseracher is forced to learn how to operate and interpret results from multiple databases in order to find all the available results. For example, to perform genetic research by locating matches or near matches of genetic information such as gene sequencing data, multiple databases may be required to obtain all available information.

Once the researcher learns how to operate all of the databases, if a researcher may need to rerun his research using that database every time the database changes in order to identify whether any new results are available. A batch program can be arranged to perform again and again the same task the researcher performed initially. While this saves the researcher time in operating the database, it may cause the researcher to have to review the old results in order to find the new ones, wasting additional researcher time looking through results that have already been reviewed.

Tools have been developed to automate the process further, but the cost of each laboratory purchasing and maintaining its own set of tools may be difficult to justify, especially for a smaller laboratory. Although several laboratories might be able to purchase a shared set of tools, or at least share access to public databases, such a sharing arrangement or public access could breach the confidentiality of the research performed using the tools.

What is needed is a method and apparatus that can simplify the research performed against multiple databases and update the results without requiring the researcher to review results seen before, all without requiring each research laboratory to purchase and maintain its own set of tools, and without compromising the confidentiality of the research.

### SUMMARY OF INVENTION

A web-based method and apparatus allows a researcher to select operations to perform against multiple databases, and the method and apparatus performs the selected operations, identifies relevant results, notifies the user of any relevant results and assembles the relevant results from the multiple databases into a consistent format. The method and apparatus periodically monitors the databases for changes and can perform selected operations against any changed portion of the databases. Data from databases is copied to a central location before the operations are performed, and secure Internet connections may be used.

Because the method and apparatus handles the database-specific details of each operation, researchers are freed from having to learn and operate multiple databases. Because changed portions of the databases are automatically identified and the operations are automatically rerun against these changed portions, research may be updated without requiring the researcher to rerun the operations and without requiring the researcher to sift through results of prior operations. Because the information in the databases is copied or brought to a central location and secure Internet connections are used, the confidentiality of the operations being performed as well as the results of the performance of those operations is preserved.

### BRIEF DESCRIPTION OF THE DRAWINGS

FIG. 1 is a block schematic diagram of a conventional computer system.

FIG. 2 is a block schematic diagram of apparatus for performing operations using multiple, changing databases according to one embodiment of the present invention.

FIG. 3A is a flowchart illustrating a method of performing operations using multiple, dynamic databases according to one embodiment of the present invention.

FIG. 3B is a method of identifying differences between versions of a database according to one embodiment of the present invention.

### DETAILED DESCRIPTION OF A PREFERRED EMBODIMENT

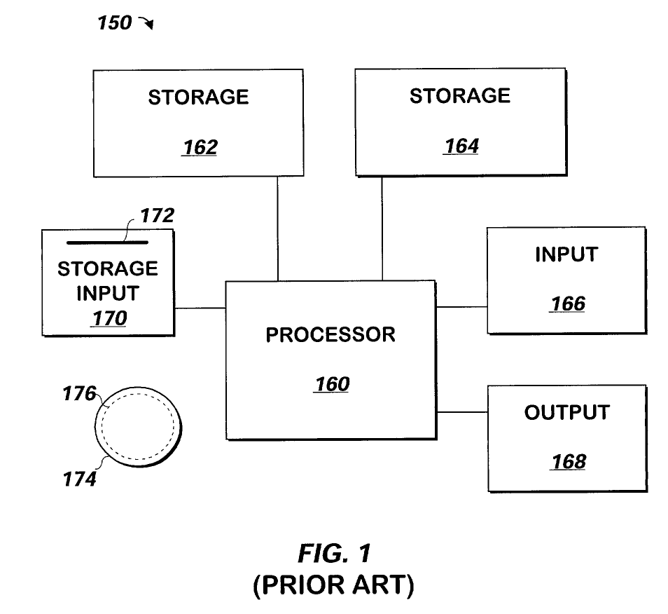

The present invention may be implemented as computer software on a conventional computer system. Referring now to FIG. 1, a conventional computer system 150 for practicing the present invention is shown. Processor 160 retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile storage, may provide storage of data or program instructions. In one embodiment, storage 164 provides longer term storage of instructions and data, with storage 162 providing storage for data or instructions that may only be required for a shorter time than that of storage 164. Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below.

In one embodiment, each computer system 150 is a conventional Pentium-compatible computer system running one or more of the Windows 95/98/NT operating systems commercially available from Microsoft Corporation of Redmond, Wash., a Macintosh computer system running the MacOS commercially available from Apple Computer Corporation of Cupertino, Calif., or a Sun Microsystems Ultra 10 workstation running the Solaris operating system commercially available from Sun Microsystems of Mountain View, Calif., although other systems may be used.

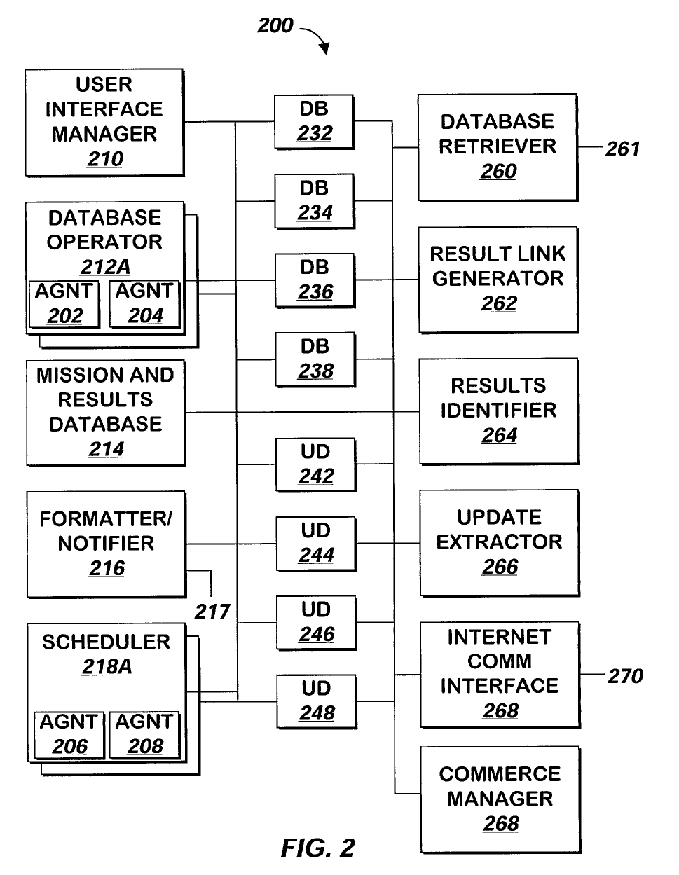

Referring now to FIG. 2, one embodiment of an apparatus for performing operations using multiple, dynamic databases is shown according to one embodiment of the present invention. Database storage 232, 234, 236, 238 are conventional storage devices such as disk, memory or a combination of disk and memory. Although all of the database storage 232, 234, 236, 238 may reside on a single device, each stores a single database. Although storage for four databases is shown in the Figure, any number of databases may be used by the present invention. One or more of the databases may change from time to time.

In one embodiment, database retriever 260 periodically retrieves each database from one of several different independent database maintainers by database retriever 260. Each database maintainer may be an organization that is independent from one another as well as from the operator of the apparatus 200. Mission and results database 214 stores the names and locations of each database that is to be stored in database storage 232, 234, 236, 238 and optionally, the frequency that the database is updated. Database retriever 260 retrieves this information from mission and results database 214 to perform the retrieval as often as the database is updated, or once per day, whichever is less frequent. For example, each night, database retriever 260 may retrieve via the Internet the different databases that are stored in database storage 232, 234, 236, 238 that are identified as having been updated using the update frequency stored in mission and results database 214. Alternatively, database retriever 260 may receive a notice from the operator of the database when an updated version of the database is available, and database retriever 260 may retrieve an updated version of the database in response to the notice. When the database retrieval is complete, database retriever 260 stores the date and time of the retrieval in mission and results database 214.

In one embodiment, the databases in database storage 232-238 include two or more of the following:

Swiss Prot

GenBank's non-redudant nucleotide database (NR-Nuc)

GenBank's non-redundant protein database (NR-Pro)

GenBank's EST database (dbEST)

Protein Data Bank's (PDB) solved protein structure database

GenBank's nucleotide patent subdivision (PAT)

NCBI's protein patent database (PATaa)

High Throughput Genomic (HTG) Sequences division of GenBank

GenBank's cumulative nightly nucleotide database updates

GenBank's cumulative nightly protein database updates

Myriad Genetics' ProNet™ database

Fred Hutchinson Cancer Research Center's Blocks+database.

In one embodiment, database storage 232, 234, 236, 238 is arranged to store two versions of each database simultaneously to allow the retrieval of a new version of each database to take place yet allow the old version of the database to be used. When database retriever 260 has completed retrieving the new version, it updates an identifier of the particular area in database storage 232, 234, 236 or 238 into which the most recent version of the database was stored to indicate the location of the most recent version of the database. This latest version is used except where otherwise noted.

To retrieve each database, database retriever 260 uses Internet communications interface 268 coupled to the Internet via input/output 270. Internet communication interface 268 is a conventional TCP/IP communication device that allows communication over the Internet, with or without an Internet service provider. In another embodiment, database retriever 260 retrieves each database from one or more tapes or disks via a drive coupled to input 261.

In one embodiment, database retriever 260 does not copy the entire database it retrieves. Instead, only certain information from the database is retrieved, for example using conventional bot, crawler or spider techniques in which a web site that provides access to the database is automatically searched and relevant information from the site is retrieved.

It is not necessary to have the databases retrieved and stored locally, that is, not separated from the apparatus by an Internet connection. The databases may be used where they are stored by the database maintainer. However, retrieval and local storage can preserve the confidence of the research performed against the databases, especially when the research is performed across a public communication facility such as the Internet.

When database retriever 260 completes retrieving a new version of a database, database retriever 260 signals update extractor 266. Update extractor 266 identifies the differences between the prior version of each of the databases stored in database storage 232, 234, 236, 238 and the most recent version retrieved by database retriever 260 and stores any new or changed data in update storage 242, 244, 246, 248. If the maintainer of the database provides this information separately, update extractor 266 retrieves this information from the maintainer of the database using Internet communication interface 268 and stores the results in the proper update storage 242, 244, 246, 248. If the maintainer of the database describes which records have been changed but does not supply the changed information separately, update extractor 266 uses the description to retrieve the changed records either from the maintainer of the database using Internet communication interface 268 or from the proper database storage 232, 234, 236 or 238. For example, if the database contains a column describing the date and time each row was added or changed, database retriever 266 may maintain in mission and results database 214 the date and time of the last two retrievals of the database along with an identifier of the database. Update extractor 266 retrieves the earlier of the two dates and times and uses the latest version of the database 232, 234, 236 or 238 to search for rows added or changed since that date and time. If the maintainer of the database does not supply this information, update extractor 266 compares the current and former version of the database in database storage 232, 234, 236 or 238 and identifies the differences by sorting the two versions and comparing each version on a record-by-record basis to identify new records and deleted records.

In the embodiment described above, a second copy of the database is retrieved in its entirety and compared against the prior version of the database. In another embodiment, the updated records are identified in the remote source of the database by update extractor 266 using the techniques described above. For example, update extractor 266 may retrieve from mission and results database 214 the date and time the original database was copied or the last update was performed for that database. Update extractor 266 may query the remote database source for records inserted, or inserted or deleted, since the original copy of the database was made or the last time the database was updated. Update extractor 266 then retrieves only the inserted records from the remote source of the database. The updates are stored in the appropriate update storage 242-248 and the insertions and any deletions are applied by update extractor 266 to the prior version of the database in database storage 232-238.

Update extractor 266 copies to an update storage 242, 244, 246, 248 from the most recently retrieved version of the database in database storage 232, 234, 236 or 238 any new or changed records. Each time update extractor 266 completes the extraction of an update of a database, update extractor 266 places an identifier of the database and the date and time of the extraction in mission and results database 214.

When a user of the system 200 desires to perform research, he or she connects to the system 200 via input/output 270 using a computer system such as a conventional PC- or Macintosh- compatible personal computer system (not shown) running a conventional web browser such as Navigator commercially available from Netscape Communications Corporation of Mountain View, California or Internet Explorer commercially available from Microsoft Corporation of Redmond Washington. User interface manager 210 allows a user to register himself to the system such as by providing a user identifier, password and email address. User interface manager 210 stores the identifier, password and e-mail address associated with one another and subsequently allows the user to log into the system using only the user identifier and password.

When the user wishes to operate the apparatus 200, the user specifies a request using user interface manager 210. The request may contain identifiers of agents to run and data to be used. In one embodiment, user interface manager 210 provides a user interface via an HTML form page delivered via the Internet using Internet communication interface 268 that allows the user to input one or more data specifications in different ways and designate any number of multiple predefined agents. Some agents may operate once, and other agents are operated periodically, such as each time one or more databases used by the agent is updated. Options for some agents may be specified via the form page that cause certain agents to operate in a specific way. For example some agents may retrieve results only for a particular type of organism (e.g. the Monitor Agent for Identical cDNAs, Monitor Agent for Similar cDNAs, Monitor Agent for Identical ESTs, Monitor Agent for Similar Proteins, Search EST Database, and the Monitor Agent for Identical Genomic DNA, described in Exhibit B), and/or only for a particular type of tissue (e.g. the Monitor Agent for Identical ESTs, and Monitor Agent for Similar Proteins, Search EST Database described in Exhibit B). The data specifications may be input either by typing it (or pasting it) into a text box or text area or by specifying in a file input box the name and path of a file on the user's local computer system (not shown) coupled to the system 200 that contains the data. The data, along with the request, is then uploaded via Internet communication interface 268 to user interface manager 210 using conventional CGI processing techniques.

When the user submits the request, user interface manager 210 stores the user's request in mission and results database along with the user's identifier and a unique serial number or other identifier for the request. User interface manager 210 signals database operator 212A with the serial number or other identifier of the request.

Database operator 212A retrieves from mission and results database 214 the identifiers of one or more agents specified in the request and data corresponding to the request using the serial number it receives from user interface manager 210 and either calls the profile agents 202, 204 specified in the request or designates the request as needing to be performed, allowing the request to be retrieved and performed by agents 202, 204 as they are available.

Database operator 212A may be replicated for scalability. There may be any number of database operators, each operating simultaneously or nearly simultaneously to execute multiple requests from one or users.

Profile agents 202, 204 contain information regarding the database-specific commands that are used to perform the operations on the one or more databases. The use of profile agents allows for a consistent syntax of operations to be performed on any or almost any of the databases stored in database storage 232, 234, 236, 238. Because the agent knows how to translate between the operation requested and the one or more commands that perform that operation on the database, the user is freed from having to know the details of implementation of each operation on each different database. Although only two profile agents 202, 204 are shown in the Figure, any number of profile agents may be used.

Each profile agent 202, 204 may be functionally-based or may be database-based. Functionally based agents are capable of performing an operation, if necessary spanning several databases, and database based agents perform different operations using a single database. In both cases, each profile agent 202, 204 has the necessary information regarding the translation of the portion of the request corresponding to that profile agent 202, 204 to the specific operations and field names of one or more databases. The profile agents may retrieve the location of each database from mission and results database 214. In one embodiment, there are three functionally-based profile agents, that perform the operations described in Exhibit A.

In one embodiment, database operator 212A directs one or more profile agents 202, 204 to perform the operations specified in the request on every database that can be used to carry out the request. In another embodiment, the operations may be performed on databases specified by the user using user interface manager 210, which passes the specified database names to database operator 212A as part of the request. In another embodiment, some or all of the databases that can perform an operation are used as defaults, which the user can override using user interface manager 210.

The results of each command carried out on databases 232, 234, 236, 238 are interpreted by profile agents 202, 204, which assemble the results into a common arrangement, format and scale across all databases for a particular operation and place the assembled results into mission and results database 214, along with the serial number or other identifier of the request and an identifier of the agent. Each agent 202, 204 signals database operator 212A when the operation has been performed and the results have been assembled into mission and results database 214.

When database operator 212A has received signals from all of the profile agents 202, 204 specified in the request, database operator 212A signals results identifier 264 and provides the serial number or other identifier of the request.

Results identifier 264 retrieves the request and the results from mission and results database 214 and interprets the results according to criteria for the agent. These criteria may depend on the database the agent was searching and the type of input the agent was using, as described in Exhibit C.

If results identifier 264 identifies results that meet the criteria of the request, results identifier 264 flags each such result in mission and results database 214. When results identifier 264 completes investigating the results of the request, results identifier 264 signals mission and results database 214 to delete the unflagged results corresponding to that request, and signals formatter/notifier 216 and result link generator 262 with the identifier of the request. It isn't necessary for the unflagged results to be deleted, and so in another embodiment, such unflagged results are not deleted.

Result link generator 262 inserts links using conventional HTML or other commands into the results that remain in mission and results database 214. The links point to additional information about the result containing the link. The additional information can include other records in mission and results database 214, records in one or more of the databases in database storage 232, 234, 236, 238, one or more external database coupled via Internet communication interface 268 and input/output 270, or any other type of additional information.

The links inserted by result link generator for each result may include a link to a web site that sells a product or service related to the result. For example, if the result is a gene sequence or other portion of a gene, the link may be a link to biotech firm that sells a vector or other product containing the sequence or portion.

Result link generator 262 may generate links using any of several techniques. For example, if a database that provided the results already contained links to other portions of the database, the link may exist, but it may point to the original source of the database, not to the locally-stored copy stored in database storage 232, 234, 266 or 238. In such embodiment, it may only be necessary to include the link as part of each result, but adjust the link to point to the locally-stored copy of the database. Result link generator 262 adjusts each such link to point to the locally-stored copy stored in database storage 232, 234, 236, 238.

Some portions of the results may correspond to additional information that was not already linked in the source of each database. For example, if the result describes a particular gene sequence, one or more links to papers written about that sequence may be inserted into the results, allowing a researcher to see additional information about the sequence by following the link. In such case, the link can be added after investigating a portion or all of each result.

These links may be generated in various ways. For example, result link generator 262 can scan one or more fields of each result record in result link database 214 corresponding to the serial number it receives and use the scan to generate a query to an external database to which the link will correspond. The results of the query may be used to generate the link. If the query turns up no results, result link generator 262 does not generate any link. If the query returns results, a link that will rerun the query, such as one containing a conventional CGI GET command, may be inserted into a field in the record in mission and results database 214.

Links to biotech companies that sell products such as vectors may be located by searching each company's site using conventional shopping robot, crawler or spider techniques. The link can include CGI commands to bring the user to a web page of a web site that will allow the user to order the product. The web site may be operated by a party that is different from the party operating the system 200, the party maintaining the databases stored in database storage 232-238 or both sets of parties. In one embodiment, the web site is operated by the same party that operates the system 200. In such embodiment, the link is made to a web page provided by commerce manager 272 which allows users to order products. The party operating commerce manager 272 may fulfill orders on its own, or may send them to another party for fulfillment. In another embodiment, commerce manager is a business to business fulfillment site matching orders with companies able to fulfill them at the lowest price.

In one embodiment, result link generator 262 maintains an internal table of such queries it has performed and the link that was generated as described above using that query. Before a new query is generated as described above, result link generator 262 compares the portion of the result it scans with its internally-generated table. If a matching entry is located in the table, result link generator 262 inserts the link from the table, and otherwise, it performs the query as described above. Result link generator 262 attempts to add links to each result marked as described above.

In another embodiment, rather than generating the links for each set of results, result link generator 262 generates the links for each entry in each database stored in database storage 232-238 each time a record is added to a database in database storage 232-238. The results can include the corresponding link so generated.

Formatter/notifier 216 formats the results remaining in mission and results database 214 corresponding to the identifier of the request received by formatter/notifier. In one embodiment, formatter/notifier 216 formats the results in summary form and provides a link to the formatted results as part of an e-mail message e-mailed to the user. In one embodiment, formatter/notifier 216 includes in the e-mail a link to user interface manager 210 (for example, using a CGI GET command) that will cause user interface manager 210 to perform a query returning links to all relevant results corresponding to the identifier of the request. The user can click on the link to see the full set of results. In one embodiment, formatter/notifier 216 stores each link associated with an identifier of the user in mission and results database for use as described below.

Formatter/notifier 216 may notify the user using other forms of communication as well. A pager message may be sent summarizing the results. A wireless modem communication to a personal digital assistant such as the conventional Palm VII product commercially available from 3COM corporation of Santa Clara, Calif. may also be used to notify the user by formatter/notifier 216. A fax may be generated and sent by formatter/notifier 216 with the summary or complete results or a telephone call may be placed with a voice message played to the recipient summarizing the results. In one embodiment, input/output 217 is coupled to the public switched telephone network to allow for paging, faxing, telephone calls or wireless communication, or a service provider may provide these services when formatter/notifier 216 provides an appropriate command to the service provider via the Internet connection at input/output 270.

Scheduler 218A periodically retrieves new requests from mission and results database 214 and assembles a list of outstanding requests that contain. The operations corresponding to the monitor agents specified in the request are run as described in Exhibit B. The operation of monitor agents 206, 208 is similar to the operation of profile agents 202, 204 described above, but use update databases 242, 244, 246, 248 in place of databases 232, 234, 236, 238.

Monitor agents 206, 208 signal scheduler 218A when they have completed performing their operations. Scheduler 218A signals results identifier 264, which identifies relevant results of the operations on the updates as described in Exhibit D and may signal result link generator 262 to generate links to databases 232, 234, 236, 238 and to other external databases as described above for the relevant results of the operations performed on the updates. Results identifier 264 signals formatter/notifier 216 with an identifier of the update results, and formatter/notifier 216 notifies the user of any relevant results as described above.

When the user who has been notified of results as described above logs in using user interface manager 210 as described above, user interface manager 210 generates a web page containing links to relevant results stored in mission and results database 214. In one embodiment, the links are organized by data and agent and links to results from monitor agents are further organized by the date the result was produced.

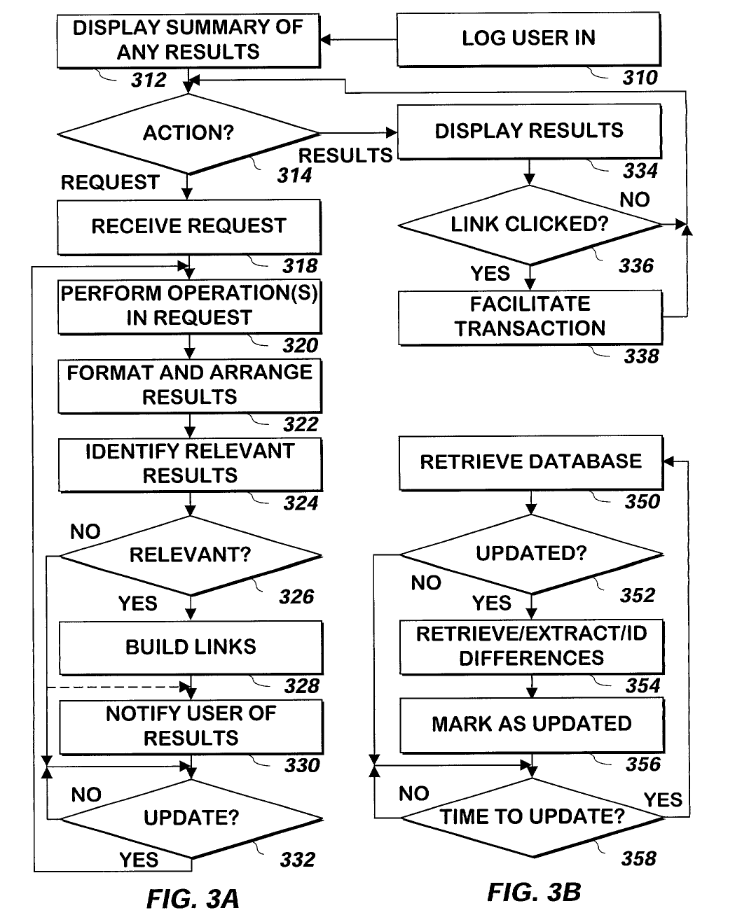

Referring now to FIG. 3A, a method of performing research on multiple dynamic databases is shown according to one embodiment of the present invention. In one embodiment, at least two of the databases are copied from different remote sources maintained by two different unrelated organizations, organizations different from an organization that performs the method of FIG. 3A. Each database may have its own unique structure and arrangement of data.

A user may log in to the system 310 for example by typing a user name and password and a summary of any results of research requested in a prior session, or hyperlinks thereto, may be displayed 312. In one embodiment, the summary of results includes hyperlinks to additional detail about the results. If the user performs an action such as clicking on any of the result links 314, additional detail about the results is displayed 334 to the user. When the user is finished reviewing the results, the user may click on a link to purchase one or more products or services related to the result. If the user does not click on the link 336, the method continues at step 314. If the user does click on the link 226, one or more transactions for the one or more products or services is facilitated as described above, and the method continues at step 314.

Otherwise, if the user indicates that he or she would like to submit a research request 314, the method continues at step 318. The request is received 318 as described above. In one embodiment, step 318 includes providing one or more forms to the user so that the user can specify the operations desired and any data to use to perform some or all of the operations. In one embodiment, the user does not need to monitor the process of the performance of the request and can log out as part of any step if desired.

In one embodiment, the request received in step 318 specifies predefined operations that may be run on one or more databases. The operations may be the names of agents that will perform the operations. In one embodiment, the operations specified in the request may be one or more operations performed by profile agents and monitor agents as described above. It isn't necessary to specify operations corresponding to both types of agents in the request: the operation or operations specified in the request may correspond to operations performed by only monitor agents or only profile agents. The request received in step 318 may contain parameters for the operations such as limitations on a specific type of species or tissue as described above.

Some or all of the operations contained in the request are performed 320 as described above. The operations may be performed by indicating to autonomous agents that the operations are ready to be performed as described above. In one embodiment, operations corresponding to monitor agents are performed at the all iterations of step 320 and in another embodiment, such operations are only performed at iterations after the first one. Operations corresponding to profile agents are performed at the first iteration of step 320 but not subsequent iterations.

In one embodiment, the performance of operations in step 320 is carried out using autonomous agents as described above. In such embodiment, step 320 includes identifying which operations are ready to be performed.

In one embodiment, all requests are performed on databases copied to a local storage area for security purposes as described above with respect to FIG. 2, and below with respect to FIG. 3B. In another embodiment, a mix of local and remote databases are used, so that if a database operator refuses to allow the copying of its database, that database may still be used, while other databases are searched using the security of local copies.

The results of the request performed in step 320 are received and the results are formatted and arranged 322 as described above. In one embodiment, the existence of any relevant results is identified 324 as described above. If any relevant results exist 326, links to information related to the relevant results are built 328 as described above. In one embodiment, step 328 is not performed until the user wishes to view the results, just prior to step 334. In another embodiment, links are generated for all records in the databases as described above, even if they have not yet appeared in any relevant results.

The user is notified 330 of the results as described above. In one embodiment, the notification is performed via e-mail, but in other embodiments, the user may be notified via a fax or telephone call or a pager notification or any other form of communication may be used. Multiple forms of communication may be used to notify the user, for example, an e-mail and a pager message may both be sent as part of step 330. If no relevant results were identified 326, the method continues at step 332 in one embodiment, although in another embodiment, the method continues at step 330 to notify the user that the request was performed without relevant results. Such embodiment is shown by the dashed line in the Figure.

If an update has been received as described above, steps 320-332 are repeated, and the operations in step 320 are only performed for operations corresponding to monitor agents. In one embodiment, these operations are performed only on the changed portion of the database identified as described above and below with respect to FIG. 3B.

In another embodiment, the results are performed on the entire database, compared with any prior results which have been stored, and the differences with the prior results identified as updated results. In one embodiment, step 332 is performed as any individual database is updated, and in another embodiment, step 332 is performed only after all of the databases that will be used in an operation have been updated, or were supposed to have been updated, for example according to a schedule.

After the user provides the request, the user is returned to step 312 as indicated by the dashed line in the Figure. The user may then wait for the results or a summary or link to a summary or the results to be displayed. If the user indicates that he wishes to see results of a request 314 the results are displayed 334, for example by building a web page corresponding to an indicated request as described above.

Referring now to FIG. 3B, a method of updating a database is shown according to one embodiment of the present invention. The method of FIG. 3B may be performed on each of several databases. The entire database may be retrieved 350. In one embodiment, step 350 may include copying the database from another location over the Internet. If the database has been updated 352, differences between the retrieved database and any previous version, for example, the next most recently retrieved version, of the database are either retrieved, extracted or identified 354 as described above. For example, if the database supplier provides a file containing the differences, the file is retrieved as part of step 354. A separate file may describe the differences and this file is retrieved as part of step 354 and used to extract the differences. Alternatively, the database itself may list a date or date and time each record was added to the database and the date and time may be used to identify differences between the two versions of the database. If the database supplier does not supply such a file, each record from the database is compared against records of the prior version of the database to identify changes. This may be performed by sorting both versions of the database, then comparing on a record-by-record basis to identify records that are new (and/or optionally deleted). In another embodiment, only new records, or new and deleted records, are retrieved from the remote version of the database and both stored as an update and applied against the original copy of the database as described above.

The database may be marked as having been updated 356 and the method repeats from step 350 when it is time to update the database 358. It is time to update the database when the current time is greater than or equal to a scheduled update time, which may be at a set time daily or on other schedules, or when a notice is received from a database maintainer.

As used herein, “BLAST” refers to the Basic Local Alignment Search Tool, described at http://www.ncbi.nlm.nih.gov/BLAST/tutorial/Altschul-1.html.

Variations of BLAST are as Follows:

BLASTp:

compares an amino acid query sequence against a protein sequence database.

BLASTn

compares a nucleotide query sequence against a nucleotide sequence database.

BLASTx

compares a nucleotide query sequence translated in all reading frames against a protein sequence database.

tBLASTn

compares a protein query sequence against a nucleotide sequence database dynamically translated in all reading frames.

tBLASTx

compares the six-frame translations of a nucleotide query sequence against the six-frame translations of a nucleotide sequence database.

Other versions of the BLAST algorithm, such as BLAST2, also known as gapped BLAST, are described throughout the literature and other searching and matching algorithms may be used in place of those listed below. For example, BLAST2 may be used in place of BLAST or vice versa in other embodiments of the present invention.

BlkProb refers to the Blocks searching system, described in Henikoff S, Henikoff JG: “Protein family classification based on searching a database of blocks”, Genomics 1994, 19:97-107, which is hereby incorporated by reference in its entirety.

The following additional references are hereby incorporated by reference in their entirety:

Fitch, W. M. (1983) “Random sequences.” J. Mol. Biol. 163:171-176.

Lipman, D. J., Wilbur, W. J., Smith T. F. & Waterman, M. S. (1984) “On the statistical significance of nucleic acid similarities.” Nucl. Acids Res. 12:215-226.

Altschul, S. F. & Erickson, B. W. (1985) “Significance of nucleotide sequence alignments: a method for random sequence permutation that preserves dinucleotide and codon usage.” Mol. Biol. Evol. 2:526-538.

Deken, J. (1983) “Probabilistic behavior of longest-common-subsequence length.” In “Time Warps, String Edits and Macromolecules: The Theory and Practice of Sequence Comparison.” D. Sankoff & J. B. Kruskal (eds.), pp. 55-91, Addison-Wesley, Reading, Mass.

Reich, J. G., Drabsch, H. & Daumler, A. (1984) “On the statistical assessment of similarities in DNA sequences.” Nucl. Acids Res. 12:5529-5543.

Altschul, S. F., Gish, W., Miller, W., Myers, E. W. & Lipman, D. J. (1990) “Basic local alignment search tool.” J. Mol. Biol. 215:403-410.

Smith, T. F. & Waterman, M. S. (1981) “Identification of common molecular subsequences.” J. Mol. Biol. 147:195-197.

Sellers, P. H. (1984) “Pattern recognition in genetic sequences by mismatch density.” Bull. Math. Biol. 46:501-514.

Gumbel, E. J. (1958) “Statistics of extremes.” Columbia University Press, New York, N.Y.

Karlin, S. & Altschul, S. F. (1990) “Methods for assessing the statistical significance of molecular sequence features by using general scoring schemes.” Proc. Natl. Acad. Sci. USA 87:2264-2268.

Dembo, A., Karlin, S. & Zeitouni, 0. (1994) “Limit distribution of maximal non-aligned two-sequence segmental score.” Ann. Prob. 22:2022-2039.

Pearson, W. R. & Lipman, D. J. (1988) “Improved tools for biological sequence comparison.” Proc. Natl. Acad. Sci. USA 85:2444-2448.

Pearson, W. R. (1995) “Comparison of methods for searching protein sequence databases.” Prot. Sci. 4:1145-1160.

Altschul, S. F. & Gish, W. (1996) “Local alignment statistics.” Meth. Enzymol. 266:460-480.

Altschul, S. F., Madden, T. L., Schäffer, A. A., Zhang, J., Zhang, Z., Miller, W. & Lipman, D. J. (1997) “Gapped BLAST and PSI-BLAST: a new generation of protein database search programs.” Nucleic Acids Res. 25:3389-3402.

Smith, T. F., Waterman, M. S. & Burks, C. (1985) “The statistical distribution of nucleic acid similarities.” Nucleic Acids Res. 13:645-656.

Collins, J. F., Coulson, A. F. W. & Lyall, A. (1988) “The significance of protein sequence similarities.” Comput. Appl. Biosci. 4:67-71.

Mott, R. (1992) “Maximum-likelihood estimation of the statistical distribution of Smith-Waterman local sequence similarity scores.” Bull. Math. Biol. 54:59-75.

Waterman, M. S. & Vingron, M. (1994) “Rapid and accurate estimates of statistical significance for sequence database searches.” Proc. Natl. Acad. Sci. USA 91:4625-4628.

Waterman, M. S. & Vingron, M. (1994) “Sequence comparison significance and Poisson approximation.” Stat. Sci. 9:367-381.

Pearson, W. R. (1998) “Empirical statistical estimates for sequence similarity searches.” J. Mol. Biol. 276:71-84.

Arratia, R. & Waterman, M. S. (1994) “A phase transition for the score in matching random sequences allowing deletions.” Ann. Appl. Prob. 4:200-225.

McLachlan, A. D. (1971) “Tests for comparing related amino-acid sequences. Cytochrome c and cytochrome c-551.” J. Mol. Biol. 61:409-424.

Dayhoff, M. O., Schwartz, R. M. & Orcutt, B. C. (1978) “A model of evolutionary change in proteins.” In “Atlas of Protein Sequence and Structure,” Vol. 5, Suppl. 3 (ed. M. O. Dayhoff), pp. 345-352. Natl. Biomed. Res. Found., Washington, D.C.

Schwartz, R. M. & Dayhoff, M. O. (1978) “Matrices for detecting distant relationships.” In “Atlas of Protein Sequence and Structure,” Vol. 5, Suppl. 3 (ed. M. O. Dayhoff), p. 353-358. Natl. Biomed. Res. Found., Washington, D.C.

Feng, D. F., Johnson, M. S. & Doolittle, R. F. (1984) “Aligning amino acid sequences: comparison of commonly used methods.” J. Mol. Evol. 21:112-125.

Wilbur, W. J. (1985) “On the PAM matrix model of protein evolution.” Mol. Biol. Evol. 2:434-447.

Taylor, W. R. (1986) “The classification of amino acid conservation.” J. Theor. Biol. 119:205-218.

Rao, J. K. M. (1987) “New scoring matrix for amino acid residue exchanges based on residue characteristic physical parameters.” Int. J. Peptide Protein Res. 29:276-281.

Risler, J. L., Delorme, M. O., Delacroix, H. & Henaut, A. (1988) “Amino acid substitutions in structurally related proteins. A pattern recognition approach. Determination of a new and efficient scoring matrix.” J. Mol. Biol. 204:1019-1029.

Altschul, S. F. (1991) “Amino acid substitution matrices from an information theoretic perspective.” J. Mol. Biol. 219:555-565.

States, D. J., Gish, W. & Altschul, S. F. (1991) “Improved sensitivity of nucleic acid database searches using application-specific scoring matrices.” Methods 3:66-70.

Gonnet, G. H., Cohen, M. A. & Benner, S. A. (1992) “Exhaustive matching of the entire protein sequence database.” Science 256:1443-1445.

Henikoff, S. & Henikoff, J. G. (1992) “Amino acid substitution matrices from protein blocks.” Proc. Natl. Acad. Sci. USA 89:10915-10919.

Jones, D. T., Taylor, W. R. & Thornton, J. M. (1992) “The rapid generation of mutation data matrices from protein sequences.” Comput. Appl. Biosci. 8:275-282.

Overington, J., Donnelly, D., Johnson M. S., Sali, A. & Blundell, T. L. (1992) “Environment-specific amino acid substitution tables: Tertiary templates and prediction of protein folds.” Prot. Sci. 1:216-226.

Henikoff, S. & Henikoff, J. G. (1993) “Performance evaluation of amino acid substitution matrices.” Proteins 17:49-61.

Gotoh, O. (1982) “An improved algorithm for matching biological sequences.” J. Mol. Biol. 162:705-708.

Fitch, W. M. & Smith, T. F. (1983) “Optimal sequence alignments.” Proc. Natl. Acad. Sci. USA 80:1382-1386.

Altschul, S. F. & Erickson, B. W. (1986) “Optimal sequence alignment using affine gap costs.” Bull. Math. Biol. 48:603-616.

Myers, E. W. & Miller, W. (1988) “Optimal alignments in linear space.” Comput. Appl. Biosci. 4:11-17.

Claverie, J.-M. & States, D. J. (1993) “Information enhancement methods for large-scale sequence-analysis.” Comput. Chem. 17:191-201.

Wootton, J. C. & Federhen, S. (1993) “Statistics of local complexity in amino acid sequences and sequence databases.” Comput. Chem. 17:149-163.

Altschul, S. F., Boguski, M. S., Gish, W. & Wootton, J. C. (1994) “Issues in searching molecular sequence databases.” Nature Genet. 6:119-129.

### Exhibit A: Operation of Profile Agents

1. Comprehensive Sequence Analysis

Given an EST, cDNA, Genomic DNA or protein sequence, this agent returns information regarding DNA identity and similarity, protein sequence identity and similarity, protein structural identity and similarity, protein interactions, and protein domain identification. Additionally, this agent investigates the patent status of DNA and protein sequences. Thus, it can be used to identify identical cDNAs, identify similar proteins, and to find patents filed on identical sequences.

The sequence analysis includes the following functions:

A. For a Nucleotide Input Sequence:

i. Functional Protein Identities and Similarities

Attempts to infer function by homology using BLAST2X (gapped BLAST) to search the SwissProt database.

ii. DNA Identities and Similarities

Finds any similar published DNA sequences using BLAST2N (gapped BLAST) to search GenBank's Non-Redundant Nucleotide (NR-nuc) database.

iii. Protein Identities and Similarities

Finds any similar published protein sequences using BLAST2X (gapped BLAST) to search GenBank's Non-Redundant Protein (NR-pro) database.

iv. Protein: Protein Interactions (ProNet Online)

Finds any similar published protein sequences using BLAST2X (gapped BLAST) to search Myriad Genetics' ProNet™ database.

V. EST Identities and Similarities

Finds any matching Expressed Sequence Tags using BLAST2N (gapped BLAST) to search GenBank's EST (dbEST) database.

vii. Protein Domains (Blocks)

Finds any conserved regions within protein families using Blimps to search Blocks version 11.0. Blocks 11.0 consists of 4034 blocks representing 994 groups documented in PROSITE 15, keyed to Swiss-Prot 36, plus 1908 blocks from 309 groups documented in PRINTS 20.0 but not represented in BLOCKS, for a total of 1303 groups.

viii. Structural Identities and Similarities

Finds any sequences with similar protein structures using BLAST2X (gapped BLAST) to search Protein Data Bank's (PDB) solved protein structure database.

ix. Identify DNA Patents

Finds identical patented sequence using BLAST2N (gapped BLAST) to search GenBank's nucleotide patent (PAT) database.

x. Genomic DNA Identities and Similarities

Finds identical Genomic matches using BLAST2N (gapped BLAST) to search the HTGS (High Throughput Genomic Sequences) division of GenBank.

xi. ‘Late Breaking’ DNA Identities and Similarities

Finds any similar published DNA sequences in the latest GenBank updates (intermediate database releases) using BLAST2N (gapped BLAST) to search all of GenBank's nucleotide updates since the latest major release.

xii. ‘Late Breaking’ Protein Identities and Similarities

Finds any similar published protein sequences in the latest GenBank updates (intermediate database releases) using BLAST2X (gapped BLAST) to search all of GenBank's protein updates since the latest major release.

B. For a protein input sequence:

i. Functional Protein Identities and Similarities

Attempts to infer function by homology using BLAST2P (gapped BLAST) to retrieve a number of top matches from the Swiss Prot database.

ii. Protein Identities and Similarities

Finds any similar published DNA sequences using BLAST2P (gapped BLAST) to search GenBank's Non-Redundant Protein (NR-pro) database.

iii. Protein: Protein Interactions (ProNet Online)

Finds any similar published protein sequences using BLAST2P (gapped BLAST) to search Myriad Genetics' ProNet™ database.

iv. EST Identities and Similarities

Finds any similar published protein sequences using TBLAST2N (gapped BLAST) to search GenBank's EST (dbEST) database.

V. Protein Domains (Blocks)

Finds any conserved regions within protein families using Blkprob to search Blocks version 11.0. Blocks 11.0 consists of 4034 blocks representing 994 groups documented in PROSITE 15, keyed to Swiss-Prot 36, plus 1908 blocks from 309 groups documented in PRINTS 20.0 but not represented in BLOCKS, for a total of 1303 groups.

vi. Structural Identities and Similarities

Finds sequences with similar protein structure using BLAST2P (gapped BLAST) to search Protein Data Bank's (PDB) solved protein structure database.

vii. Identify Protein Patents

Finds identical patented sequences using BLAST2P (gapped BLAST) to search GenBank's protein patent (PAT) database.

vii. ‘Late Breaking’ Protein Identities and Similarities

Finds any similar published protein sequences in the latest GenBank updates (intermediate database releases) using BLAST2P (gapped BLAST) to search all of GenBank's protein updates since the latest major release.

2. Retrieve Assembled ESTs

Upon submitting an EST, cDNA or Genomic DNA sequence, this agent searches Gene Indices for the presence of cDNA containing sequence identical to the input DNA. The Gene Indices searched are for human, mouse, Arabidopsis and Drosophila. The Gene Index corresponding to the species of the input sequence will be searched. A consensus sequence (contig) and the top matching clusters are returned. Pairwise sequence comparisons and a graphical view of the cluster are also provided. Thus, this agent can be used to identify potentially full-length cDNA sequences, if available, and reveal splice variants and other polymorphisms within a DNA sequence.

This agent searches gene indices for the presence of cDNA containing sequences identical to the input DNA. The Gene Indices include human, mouse, Arabidopsis and Drosophila. The Gene Index corresponding to the species of the input sequence is searched. A consensus sequence and the top matching clusters (contigs) are returned. Pairwise sequence comparisons and a graphical view of the cluster are also provided. Thus, this agent can be used to identify potentially full-length CDNA sequences, if available, and reveal splice variants and other polymorphisms within a DNA sequence.

The Retrieve Assembled ESTs agent uses the BLAST2N algorithm to search the Gene Indices. Databases that may be screened are the Gene Indices of Human, Mouse, Arabidopsis, and Drosophila. These databases are updated every two months. The basis for a match depends on the input sequence type.

3. Retrieve and Analyze Human Genome

Upon inputting an EST, cDNA, or Genomic DNA sequence, the Retrieve and Analyze Human Genome agent searches a Human Genome Database to identify a Genomic DNA clone containing sequences identical to the input DNA. The gene structure of the retrieved Genomic fragment is annotated showing predicted exon and intron positions and promoter sequences. Thus, this agent can predict the location and gene structure of all genes present on a given Genomic fragment. This agent also specializes in annotating “unfinished” human Genomic sequences.

### Exhibit B: Operation of Monitor Agents

1. Monitor for Identical ESTs

Upon inputting an EST, cDNA or Genomic DNA sequence, this agent monitors the daily GenBank database updates for sequences identical to the input sequence. This agent can be customized to search for identical ESTs that originate from one or more particular organisms and tissue types. The Monitor for Identical ESTs agent uses the BLAST2N algorithm to search the nightly dbEST database updates for the presence of identical ESTs. The basis for a match depends on the input sequence type. In one embodiment, only highly conserved sequences will be identified from an organism different from the organism of the input sequence.

2. Monitor for Identical cDNAs

Upon inputting an EST or cDNA sequence, this agent monitors the daily GenBank database updates for cDNA containing sequences identical to the input DNA. This agent can be customized to search for identical cDNAs that originate from a particular organism. In one embodiment, only highly conserved sequences will be identified from an organism different from the organism of the input sequence.

3. Monitor for Similar cDNAs

Upon inputting an EST or cDNA sequence, this agent monitors the daily GenBank database updates for similar cDNAs. The Monitor for Similar cDNAs agent uses the BLAST2N algorithm to search the nightly non-cumulative GenBank nucleotide database updates. This agent can be used to monitor for new gene family members. This agent can be customized to search for similar cDNAs that originate from a particular organism.

4. Monitor for Similar Proteins, Search EST Database

Upon inputting an EST, cDNA or protein sequence, this agent monitors the daily GenBank database updates for sequences that upon translation are similar to the input sequence and that originate from a particular organism and tissue. The Monitor for Similar Proteins, Search EST Database agent uses the TBLAST2N and TBLAST2X algorithms to search the nightly dbEST database updates. This agent can be used to monitor for new gene family members.

5. Monitor for Similar Proteins

Upon inputting an EST, cDNA or protein sequence, this agent monitors the daily GenBank database updates for new proteins that are similar to a sequence of interest. The Monitor for Similar Proteins agent uses the BLAST2P and BLAST2X algorithms to search the nightly non-cumulative GenBank database updates. This agent can be used to monitor for new gene family members.

6. Monitor for DNA Patents

Upon inputting an EST, CDNA, or Genomic DNA sequence, this agent monitors the GenBank databases for the presence of a patent filed on an identical DNA sequence. The Monitor for DNA Patents agent uses the BLAST2N algorithm to search the nightly non-cumulative GenBank database updates. Matches to sequences within the patented subdivision of GenBank are reported.

7. Monitor for Protein Patents

Upon inputting an EST, cDNA or protein sequence, this agent monitors the NCBI protein patent database for the presence of a patent filed on an identical protein sequence. The Monitor for Protein Patents agent uses the BLAST2P and BLAST2X algorithms to search the updates of the NCBI PATaa (protein patent) database.

8. Monitor for Identical Genomic DNA

Upon inputting an EST, cDNA, Genomic DNA or protein sequence, this agent monitors the daily GenBank database updates for Genomic DNA fragments that contain sequences identical to the input sequence. The Monitor for Identical Genomic DNA agent uses the BLAST2N and TBLAST2N algorithms to search the nightly non-cumulative GenBank database updates.

9. Monitor Human Genome Database

Upon inputting an EST, CDNA, or Genomic DNA sequence, this agent monitors a daily updated Human Genome Database for Genomic DNA fragments that contain sequences identical to the input DNA. This agent specializes in identifying and annotating “unfinished” human Genomic sequences.

This agent monitors the daily GenBank database updates for sequences identical to the input sequence and can be customized to search for ESTs that originate from a particular organism and/or tissue. In one embodiment, only highly conserved sequences will be identified from an organism different from the organism of the input sequence.

The Monitor for Identical ESTs agent uses the BLAST2N algorithm to search the nightly dbEST database updates for the presence of identical ESTs.

10. Patent Agent

This agent may be used in place of agents 6 and 7 above and operates as a profile agent when initially selected, and subsequently operates as a monitor agent. Upon inputting an EST, cDNA, genomic DNA, or protein sequence, this Agent searches and monitors Derwent's GENESEQ patent database and GenBank's Patent Division and identifies patent information related to the sequence. The Patents Agent uses the BLAST2 (gapped BLAST) algorithm to search the GenBank patent division database and Derwent's GeneSeq patent database for similar proteins (using BLAST2P) and nucleotides (using BLAST2N).

### Exhibit C: Identifying Results for Profile Agents

1. Comprehensive Sequence Analysis

A. For a nucleotide input sequence, results identifier 264 identifies results as follows:

i. Functional Protein Identities and Similarities

The top three matches, determined by the “Basis for a Match” specified below, are reported for this section.

Note: All “tied” matches (separate records with identical E Value scores) are included in the results, except those in the “none” range below.

Basis for a Match

| Confidence Level | E Value Range |
|---|---|
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

ii. DNA Identities and Similarities

The top three matches, determined by the “Basis for a Match” specified below, are reported for this section.

Note: All “tied” matches (separate records with identical E Value scores) are included in the results.

Basis for a Match

| Confidence Level | E Value Range |
|---|---|
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

iii. Protein Identities and Similarities

The top three matches, determined by the “Basis for a Match” specified below, are reported for this section.

Note: All “tied” matches (separate records with identical E Value scores) are included in the results, except those in the “none” range below.

Basis for a Match

| Confidence Level | E Value Range |
|---|---|
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

iv. Protein: Protein Interactions (ProNet Online)

The top three matches, determined by the “Basis for a Match” specified below, are reported for this section.

Note: All “tied” matches (separate records with identical E Value scores) are included in the results, except those in the “none” range below.

Basis for a Match

| Confidence Level | E Value Range |
|---|---|
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

V. EST Identities and Similarities

The top three matches, determined by the “Basis for a Match” specified below, are reported for this section.

Note: All “tied” matches (separate records with identical E Value scores) are included in the results, except those in the “none” range below.

Basis for a Match

| Confidence Level | Identity Range |
|---|---|
| HIGH | ≧95% identity over 75 nucleotides |
| MEDIUM | ≧80% and <95% identity over 75 |
| | nucleotides |
| NONE | <80% identity or less than 75 |
| | nucleotides |

vi. Protein Domains (Blocks)

All matches, determined by the “Basis for a Match” specified below, are reported for this section.

Basis for a Match

| Confidence Level | Score |
|---|---|
| HIGH | >1400 |
| MEDIUM | ≦1400 and ≧1100 |
| LOW | <1100 and ≧900 |
| NONE | <900 |

vii. Structural Identities and Similarities

All matches, determined by the “Basis for a Match” specified below, are reported for this section.

Basis for a Match

| Confidence Level | Identity Range |
|---|---|
| HIGH | ≧95% over at least 75% of input |
| | sequence |
| MEDIUM | <95% and ≧60% over at least 75% of |
| | input sequence |
| LOW | <60% and ≧40% over at least 75% of |
| | input sequence |
| NONE | <40% or an alignment of ≦75% of |
| | input sequence |

viii. Identify DNA Patents

All matches, determined by the “Basis for a Match” specified below, are reported for this section.

Basis for a Match
at least 97% identity over 100
nucleotides

ix. Genomic DNA Identities and Similarities

All matches, determined by the “Basis for a Match” specified below, are reported for this section.

Basis for a Match
at least 95% identity over 75
nucleotides

x. ‘Late Breaking’ DNA Identities and Similarities

The top three matches, determined by the “Basis for a Match” specified below, are reported for this section.

Note: All “tied” matches (separate records with identical E Value scores) are included in the results.

Basis for a Match

| Confidence Level | E Value Range |
|---|---|
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

xi. ‘Late Breaking’ Protein Identities and Similarities

The top three matches, determined by the “Basis for a Match” specified below, are reported for this section.

Note: All “tied” matches (separate records with identical E Value scores) are included in the results, except those in the “none” range below.

Basis for a Match

| Confidence Level | E Value Range |
|---|---|
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

B. For a protein input sequence, results identifier 264 identifies results as follows:

i. Functional Protein Identities and Similarities

The top three matches, determined by the “Basis for a Match” specified below, are reported for this section.

Note: All “tied” matches (separate records with identical E Value scores) are included in the results, except those in the “none” range below.

Basis for a Match

| Confidence Level | E Value Range |
|---|---|
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

ii. Protein Identities and Similarities

The top three matches, determined by the “Basis for a Match” specified below, are reported for this section.

Note: All “tied” matches (separate records with identical E Value scores) are included in the results, except those in the “none” range below.

Basis for a Match

| Confidence Level | E Value Range |
|---|---|
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

iii. Protein: Protein Interactions (ProNet Online)

The top three matches, determined by the “Basis for a Match” specified below, are reported for this section.

Note: All “tied” matches (separate records with identical E Value scores) are included in the results, except those in the “none” range below.

Basis for a Match

| Confidence Level | E Value Range |
|---|---|
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

iv. EST Identities and Similarities

The top three matches, determined by the “Basis for a Match” specified below, are reported for this section.

Note: All “tied” matches (separate records with identical E Value scores) are included in the results, except those in the “none” range below.

Basis for a Match

| Confidence Level | E Value Range |
|---|---|
| HIGH | <1E⁻³⁰ |
| MEDIUM | ≦1E⁻⁸ and >1E⁻³⁰ |
| LOW | <0.1 and >1E⁻⁸ |
| NONE | ≧0.1 |

V. Protein Domains (Blocks)

All matches determined by the “Basis for a Match” specified below, are reported for this section, except those in the “none” range below.

Basis for a Match

| Confidence Level | Score |
|---|---|
| HIGH | >1400 |
| MEDIUM | ≦1400 and ≧1100 |
| LOW | >1100 and ≧900 |
| NONE | <900 |

vi. Structural Identities and Similarities

The top three matches, determined by the “Basis for a Match” specified below, are reported for this section.

Note: All “tied” matches (separate records with identical E Value scores) are included in the results.

Basis for a Match

| Confidence Level | Identity Range |
|---|---|
| HIGH | ≧95% over at least 75% of |
| | input sequence |
| MEDIUM | <95% and ≧60% over at least |
| | 75% of input sequence |
| LOW | <60% and ≧40% over at least |
| | 75% of input sequence |
| NONE | >40% or an alignment of ≦75% of |
| | input sequence |

vii. Identify Protein Patents

All matches, determined by the “Basis for a Match” specified below, are reported for this section.

Basis for a match
at least 99% identity over 50
amino acids

vii. ‘Late Breaking’ Protein Identities and Similarities

The top three matches, determined by the “Basis for a Match” specified below, are reported for this section.

Note: All “tied” matches (separate records with identical E Value scores) are included in the results.

Basis for a Match

| Confidence | |
|---|---|
| Level | E Value Range |
| HIGH | <1E⁻³⁰ |
| MEDIUM | ≦1E⁻⁸ and ≧1E⁻³⁰ |
| LOW | <0.1 and >1E⁻⁸ |
| NONE | ≧0.1 |

2. Retrieve Assembled ESTs

The basis for a match depends upon the type of input sequence:

| Sequence type | Basis for a match |
|---|---|
| EST | at least 95% identity over |
| | 75 nucleotides |
| cDNA | at least 97% identity over |
| | 75 nucleotides |
| Genomic | at least 95% identity over |
| DNA | 75 nucleotides |

3. Retrieve and Analyze Human Genome

All Genomic DNA clones containing sequences identical to the input DNA are returned in the results.

### Exhibit D: Identifying Results for Monitor Agents

All results matching the criteria listed in the “Basis for a Match” are returned

1. Monitor for Identical ESTs

The basis for a match depends on the input sequence type.

| Sequence type | Basis for a match |
|---|---|
| EST | at least 95% identity over |
| | 75 nucleotides |
| cDNA | at least 97% identity over |
| | 100 nucleotides |
| Genomic | at least 95% identity over |
| DNA | 75 nucleotides |

2. Monitor for Identical cDNAs

The basis for a match depends on the input sequence type.

| Sequence type | Basis for a match |
|---|---|
| EST | at least 95% identity over |
| | 75 nucleotides |
| cDNA | at least 97% identity over |
| | 100 nucleotides |

3. Monitor for Similar cDNAs

The basis for a match is the same for all input sequence types.

| Sequence type | Basis for a match |
|---|---|
| EST/cDNA | at least 40% identity over |
| | 100 nucleotides |

4. Monitor for Similar Proteins, Search EST Database

The basis for a match is the same for all input sequence types.

| Sequence type | Basis for a match |
|---|---|
| EST/cDNA/Protein | at least 20% identity over 50 |
| | amino acids and E value <= .001 |

5. Monitor for Similar Proteins

The basis for a match is the same for all input sequence types.

| Sequence type | Basis for a match |
|---|---|
| EST/cDNA/Protein | at least 20% identity over 50 |
| | amino acids and E value <= 3.0 |

6. Monitor for DNA Patents

The basis for a match depends on the input sequence type.

| Sequence type | Basis for a match |
|---|---|
| EST | at least 95% identity over 75 |
| | nucleotides |
| cDNA | at least 97% identity over 100 |
| | nucleotides |
| Genomic | at least 95% identity over 75 |
| DNA | nucleotides |

7. Monitor for Protein Patents

The basis for a match is the same for all input sequence types.

| Sequence type | Basis for a match |
|---|---|
| EST/cDNA/Protein | at least 99% identity over 50 |
| | amino acids |

8. Monitor for Identical Genomic DNA

The basis for a match depends on the input sequence type.

| Sequence type | Basis for a match |
|---|---|
| EST/cDNA/ | at least 95% identity over 75 |
| Genomic DNA | nucleotides |
| Protein | >90% identity over 50 |
| | amino acid |

9 Monitor Human Genome Database

The basis for a match depends on the input sequence type.

| Input | |
|---|---|
| Sequence type | Basis for a match |
| EST/cDNA/ | at least 95% identity over 75 |
| Genomic DNA | nucleotides |
| Protein | at least 90% identity over 50 |
| | amino acids |

10. Patent Agent

The basis for a match depends on the input sequence type.

| Sequence type | Basis for a match |
|---|---|
| EST/cDNA/ | at least 85% identity over 75 |
| Genomic DNA | nucleotides |
| Protein | at least 85% identity over 50 |
| | amino acid |

What is claimed is:

1. A method of performing a plurality of operations on a plurality of first sets of information, the method comprising:
assembling, at a single location, at least one second set of information from the plurality of first sets of information available at a plurality of remote locations; and
performing a plurality of the plurality of operations on the at least one second set of information at the single location.

2. The method of claim 1 additionally comprising the step of, for each of at least one of the plurality of operations:
performing at a first time said at least one of the plurality of operations on at least one of the at least one second set of information; and
performing at a second time different from the first time said at least one of the plurality of operations on at least one of the at least one second set of information.

3. The method of claim 2, wherein the performing at a second time step is responsive to at least one change in at least one of the plurality of first sets of information corresponding to the at least one second set of information used by the at least one of the plurality of operations.

4. The method of claim 3, additionally comprising identifying at least one of the at least one change.

5. The method of claim 2, wherein the performing at a first time step generates a first set of results and the performing at a second time step generates a second set of results at least substantially different from the first set of results.

6. The method of claim 1 additionally comprising the steps of:
determining an existence of relevant results of the performing step; and
responsive to the determining step, providing a notice of the existence of relevant results.

7. The method of claim 6 wherein the notifying step comprises at least one selected from e-mailing, paging, faxing and telephoning.

8. The method of claim 1 wherein at least one of the plurality of first sets of information comprises gene sequencing information.

9. The method of claim 1 additionally comprising receiving an indication of the plurality of operations via an Internet.

10. The method of claim 9, wherein the indication is received via a secure Internet connection.

11. The method of claim 9, wherein the indication is received by a first organization, and a first at least one of the plurality of first sets of information is maintained by a second organization, different from the first organization.

12. The method of claim 11, wherein a second at least one of the plurality of first sets of information is maintained by a third organization independent of the first organization and the second organization.

13. The method of claim 1, additionally comprising the step of building at least one link to at least one information source responsive to at least a portion of at least one of the at least one second set of information.

14. A computer program product comprising a computer useable medium having computer readable program code embodied therein for performing a plurality of operations on a plurality of first sets of information, the computer program product comprising:
computer readable program code devices configured to cause a computer to assemble, at a single location, at least one second set of information from the plurality of first sets of information available at a plurality of remote locations; and
computer readable program code devices configured to cause a computer to perform a plurality of the plurality of operations on the at least one second set of information at the single location.

15. The computer program product of claim 14 additionally comprising computer readable program code devices configured to cause a computer to, for each of at least one of the plurality of operations:
perform at a first time said at least one of the plurality of operations on at least one of the at least one second set of information; and
perform at a second time different from the first time said at least one of the plurality of operations on at least one of the at least one second set of information.

16. The computer program product of claim 15, wherein the computer readable program code devices configured to cause a computer to perform at a second time are responsive to at least one change in at least one of the plurality of first sets of information corresponding to the at least one second set of information used by the at least one of the plurality of operations.

17. The computer program product of claim 16, additionally comprising computer readable program code devices configured to cause a computer to identify at least one of the at least one change.

18. The computer program product of claim 15, wherein the computer readable program code devices configured to cause a computer to perform at a first time generate a first set of results and the computer readable program code devices configured to cause a computer to perform at a second time generate a second set of results at least substantially different from the first set of results.

19. The computer program product of claim 14 additionally comprising:
computer readable program code devices configured to cause a computer to determine an existence of relevant results of the performing step; and
computer readable program code devices configured to cause a computer to, responsive to the determining step, provide a notice of the existence of relevant results.

20. The computer program product of claim 19 wherein the computer readable program code devices configured to cause a computer to notify comprise at least one selected computer readable program code devices configured to cause a computer to e-mail, computer readable program code devices configured to cause a computer to page, computer readable program code devices configured to cause a computer to fax and computer readable program code devices configured to cause a computer to telephone.

21. The computer program product of claim 14 wherein at least one of the first sets of information comprises gene sequencing information.

22. The computer program product of claim 14 additionally comprising computer readable program code devices configured to cause a computer to receive an indication of the plurality of operations via an Internet.

23. The computer program product of claim 22, wherein the indication is received via a secure Internet connection.

24. The computer program product of claim 22, wherein the indication is received by a first organization, and a first at least one of the plurality of first sets of information is maintained by a second organization, different from the first organization.

25. The computer program product of claim 24, wherein a second at least one of the plurality of first sets of information is maintained by a third organization independent of the first organization and the second organization.

26. The computer program product of claim 14, additionally comprising computer readable program code devices configured to cause a computer to build at least one link to at least one information source responsive to at least a portion of at least one of the at least one second set of information.

27. An apparatus for performing a plurality of operations on a plurality of first sets of information, the apparatus comprising:
an information retriever having an input operatively coupled to receive at least a portion of the plurality of first sets of information available at a plurality of remote locations, the information retriever for assembling at a single location at least one second set of information responsive to the plurality of first sets of information received at the information retriever input; and
an information operator coupled to the information retriever, the information operator for performing a plurality of the plurality of operations on the at least one second set of information at the single location.

28. The apparatus of claim 27 additionally comprising a scheduler coupled to the information retriever, the scheduler for, for each of at least one of the plurality of operations, performing said at least one of the plurality of operations on at least one of the at least one second set of information at a first time and performing said at least one of the plurality of operations on at least one of the at least one second set of information at a second time different from the first time.

29. The apparatus of claim 28, wherein scheduler performs the at least one of the plurality of operations the second time responsive to at least one change in at least one of the plurality of first sets of information corresponding to the at least one second set of information used by the at least one of the plurality of operations.

30. The apparatus of claim 29:
additionally comprising an update extractor having an input coupled to receive at least a portion of at least one of the plurality of first sets of information, the update extractor for identifying at least one of the at least one change; and
wherein the scheduler is coupled to the update extractor and performs the at least one of the plurality of operations the second time responsive to the update extractor identifying the at least one of the at least one change.

31. The method of claim 28, wherein the scheduler produces a first set of results responsive to the scheduler performing at a first time and produces a second set of results at least substantially different from the first set of results responsive to the scheduler performing at the second time.

32. The apparatus of claim 28 additionally comprising:
a results identifier coupled to at least one of the scheduler and the information operator, the results identifier for receiving a plurality of results of at least one of the plurality of the plurality of operations and the at least one of the plurality of operations and selecting a number, at least zero, of relevant results less than a number of results received by the results identifier; and
a formatter/notifier coupled to the results identifier, the formatter/notifier for providing at an output a notice of an existence of relevant results responsive to the number selected by the results identifier.

33. The apparatus of claim 32 wherein the notice provided by the formatter/notifier comprises at least one selected from an e-mail message, a page message, a fax message and telephone call.

34. The apparatus of claim 27 wherein at least one of the at least one second set of information comprises gene sequencing information.

35. The apparatus of claim 27 additionally comprising a user interface manager coupled to the information operator and the scheduler, the user interface manager having an input operatively coupled for receiving an indication of the plurality of operations via an Internet.

36. The apparatus of claim 35, wherein the indication is received by the user interface manager via a secure Internet connection.

37. The apparatus of claim 35, wherein the apparatus is received by a first organization, and a first at least one of the plurality of first sets of information is maintained by a second organization, different from the first organization.

38. The apparatus of claim 37, wherein a second at least one of the first sets of information is maintained by a third organization independent of the first organization and the second organization.

39. The apparatus of claim 27, additionally comprising a result link identifier coupled to the information retriever, the result link identifier for building at least one link to at least one information source responsive to at least a portion of at least one of the at least one second set of information.
